(19) United States
(12) Patent Application Publication
(10) Pub. No.: US 2016/0333168 A1
(43) Pub. Date: Nov. 17, 2016

(54) THERMOPLASTIC MOULDING MATERIALS

(71) Applicant: LANXESS Deutschland GmbH, Cologne (DE)

(72) Inventors: Detlev JOACHIMI, Krefeld (DE); Thomas LINDER, Cologne (DE)

(21) Appl. No.: 15/151,677

(22) Filed: May 11, 2016

(30) Foreign Application Priority Data
May 12, 2015 (EP) 15167302.7

(51) Int. Cl. C08K 5/098; C08K 3/16; C08K 7/14; C08K 5/053

(52) U.S. Cl. CPC C08K 5/098; C08K 5/053; C08K 3/16; C08K 7/14

(57) ABSTRACT

Heat-stabilized polyamide-based compositions include a stabilizing system of at least one salt of citric acid and dipentaerythritol. The heat stabilized polyamide compositions are suitable for moulding materials, which in turn may be injection moulded, blow moulded, or extruded to produce articles of manufacture.

The present invention relates to heat-stabilized polyamide-based compositions based on at least one salt of citric acid and dipentaerythritol, to moulding materials produced therefrom and in turn to injection moulded, blow-moulded or extruded articles of manufacture produced therefrom.

### BACKGROUND INFORMATION

Polyamides, in particular partly crystalline polyamides, are often used as materials of construction for mouldings which are exposed to elevated temperatures over a prolonged period during their lifetime. It is necessary for a great many applications that the materials of construction be sufficiently stable toward the attendant thermos-oxidative damage, in particular for engine bay applications in motor vehicles.

Glass fibre-reinforced polyamide 66 compounds have become established in automobile construction for the production of articles of manufacture subject to high levels of thermal stress, wherein high levels of thermal stress is to be understood as meaning temperatures of 180° C. to 240° C., temperatures which may nowadays readily occur in the engine bay of motor vehicles with combustion engines, in particular when the articles of manufacture are turbo charge air pipes, intake pipes, cylinder head covers, charge air coolers or engine covers.

On account of the increases in motor vehicle engine performance realized in recent years, manufacturers impose ever higher requirements on the materials used for producing these articles of manufacture.

Polyamides generally exhibit a deterioration in their mechanical properties when they are subjected to elevated temperatures over a prolonged period. This effect is based primarily on oxidative damage to the polyamide at elevated temperatures (thermo-oxidative damage). A prolonged period in the context of the present invention means longer than 100 hours; elevated temperatures in the context of the present invention means higher than 80° C.

The stability of thermoplastic moulding materials/articles of manufacture produced therefrom to thermo-oxidative damage is typically assessed by comparison of mechanical properties, in particular of impact resistance, of breaking stress and breaking elongation measured in the tensile test as per ISO 527, and of elastic modulus at defined temperature, over a defined period.

The thermo-oxidative degradation of thermoplastic polyamide-based moulding compositions at elevated temperatures over a prolonged period generally cannot be prevented, only delayed, with stabilizer systems. The requirements imposed on polyamide-based moulding materials/articles of manufacture produced therefrom in high-temperature applications are not yet sufficiently met by prior art heat-stabilizing systems. Thus, for example, prior art articles of manufacture experience a marked drop in impact resistance or breaking stress, usually to less than 50% of the initial value, after 1000 hours of long-term storage at temperatures of 180° C. to 200° C.

WO 2015/011001 A1 describes, inter alia, citrate-comprising polyamide-based moulding materials and articles of manufacture produced therefrom having good thermal stability. However, the thermal stability of articles of manufacture produced according to WO 2015/011001 A1 does not always prove satisfactory.

The problem addressed by the present invention was to further improve the stabilization of polyamides, as well as articles of manufacture fabricated therefrom, towards thermo-oxidative and photo-oxidative damage.

### SUMMARY

The solution to the problem and subject-matter of the present invention are compositions that include:
A) at least one polyamide and/or at least one copolyamide,
B) at least one salt of citric acid,
C) dipentaerythritol, and
D) at least one filer or reinforcer.

It has surprisingly been determined that compositions of polyamide and/or copolyamide may be further stabilized by a stabilizing system that includes at least one salt of citric acid and dipentaerythritol.

### DETAILED DESCRIPTION OF THE INVENTION

It is noted for the avoidance of doubt, that the scope of the invention encompasses all below-referenced definitions and parameters referred to in general terms or within preferred ranges in any desired combinations. Any ranges disclosed encompass all ranges from endpoint to endpoint as well as any ranges from a value between the disclosed endpoints to any endpoint or to any other value between the disclosed endpoints. In the context of the present application the salts of citric acid are also referred to as citrates, the term salt also encompassing monohydrates and polyhydrates. Citations of standards refer to the version valid on the application date of the present application, but are not intended to be solely restricted to the same, as standards and procedures change over time.

The compositions according to the invention, also generally referred to in the plastics industry as moulding materials, are obtained upon processing the components A) to D), and optionally E), F) and G), discussed further below, preferably as pelletized material, in the form of extrudates or as powder. Preparation may be effected by mixing the inventive compositions in at least one mixing assembly, preferably a compounder, particularly preferably a co-rotating twin-screw extruder. The mixing of the components A) to D), and optionally at least one further component E), F) or G), to produce compositions of the invention in the form of powders, pelletized materials or extrudates is often referred to in the plastics industry as compounding. This gives, as intermediates, moulding materials based on the inventive compositions. These moulding materials—also known as thermoplastic moulding materials—may either be composed exclusively of the components A), B), C) and D), or else may contain, in addition to the components A), B), C) and D), further components, preferably at least one of the components E) to G) defined hereinbelow.

The present invention thus also provides moulding materials and articles of manufacture based on inventive compositions which comprise amounts of component A) of about 15 to about 94.85 wt %, component B) of about 0.05 to about 10 wt %, component C) of about 0.1 to about 5 wt % and component D) of about 5 to about 70 wt %, wherein the sum of all weight percentages is always 100 wt %.

In the case of the moulding materials, the components A), B), C) and D) may be varied within the specified quantitative ranges such that the sum of all weight percentages is always 100. In the case of the moulding materials and articles of manufacture produced therefrom, the composition comprises at least about 40 wt % of the components A), B), C) and D), and if additional components are included, the remaining constituents being added substances selected by those skilled in the art in accordance with the later use of the articles of manufacture, preferably from, but not limited to, at least one of the components E) to G) defined hereinbelow. When the moulding materials comprise, in addition to the components A), B), C) and D), further components, in particular at least one of the components E), F) and/or G) listed hereinbelow, the proportion of at least one of the components A), B), C) and D) is reduced by an extent such that the sum of all weight percentages in the moulding material is always 100 wt %.

In an embodiment, the compositions and also the moulding materials and articles of manufacture produced therefrom further comprise at least one further heat stabilizer E) distinct from component B), preferably in amounts of about 0.03 to about 0.5 wt %, wherein in the moulding materials the proportion of at least one of the components A), B), C) and D) is to be varied such that the sum of all weight percentages is 100 wt % and the heat stabilizer is at least one selected from the group of copper halides.

In an embodiment, the compositions and the moulding materials and articles of manufacture produced therefrom further comprise, in addition to the components A) to E), at least one alkali metal halide F), preferably in amounts of about 0.01 to about 0.5 wt %, wherein in the moulding materials the proportion of at least one of the components A) to E) is to be varied such that the sum of all weight percentages is 100 wt %. In an embodiment, components E) and F) are always employed together.

In an embodiment, the compositions and the moulding materials and articles of manufacture produced therefrom further comprise, in addition to the components A) to F) or instead of the components E) and/or F), at least one further additive G), preferably in amounts of about 0.05 to about 5 wt %, wherein in the moulding materials the proportion of at least one of the components A) to F) is to be varied such that the sum of all weight percentages is 100 wt %.

### Component A)

The polyamides for use as component A) may be amorphous polyamides or partly crystalline polyamides. The inventive stabilizer system composed of the components B) and C) is particularly preferably employed for polyamides used in high temperature applications, very particularly preferably for partly crystalline polyamides having a melting point of at least 180° C. or amorphous polyamides having a glass transition temperature of at least 150° C.

The nomenclature of the polyamides used in the context of the present application corresponds to the international standard, the first number(s) denoting the number of carbon atoms in the starting diamine and the last number(s) denoting the number of carbon atoms in the dicarboxylic acid. When only one number is indicated, as in the case of PA 6, this means that the starting material was an α,δ-aminocarboxylic acid or the lactam derived therefrom, i.e. ε-caprolactam in the case of PA 6; for further information, reference is made to H. Domininghaus, Die Kunststoffe und ihre Eigenschaften [Polymers and Their Properties], pages 272 ff., VDI-Verlag, 1976 and to DIN EN ISO 1874-1:2011-03.

It an embodiment, component A) may be at least one partly crystalline polyamide, particularly preferably at least polyamide 6 (PA6) [CAS No. 25038-54-4] or polyamide 66 (PA66) [CAS No. 32131-17-2], in particular polyamide 66.

The PA 6 and PA 66 are partly crystalline polyamides. According to DE 10 2011 084 519 A1 partly crystalline polyamides have an enthalpy of fusion of about 4 to about 25 J/g measured by the DSC method to ISO 11357 in the 2nd heating and integration of the melt peak. By contrast, amorphous polyamides have an enthalpy of fusion of less than about 4 J/g measured by the DSC method to ISO 11357 in the 2nd heating and integration of the melt peak.

In one embodiment a blend of different polyamides may be used as component A).

It is especially particularly preferable when polyamide 6 or polyamide 66 having relative solution viscosities in m-cresol of about 2.0 to about 4.0 are used as component A). It is especially very particularly preferable when polyamide 66 having a relative solution viscosity in m-cresol of about 2.6 to about 3.2 is used.

Methods of determining relative solution viscosity comprise measuring the flow times for a dissolved polymer through an Ubbelohde viscometer in order then to determine the viscosity difference between the polymer solution and its solvent, in this case m-cresol (1% solution). Applicable standards are DIN 51562; DIN ISO 1628 or corresponding standards. In the context of the present invention the viscosity measurement is performed in sulfuric acid with an Ubbelohde viscometer to DIN 51 562 part 1 with capillary II at 25° C. (±0.02° C.).

The polyamides for use as component A) may be produced by various methods and synthesized from different monomers. Polyamides are obtainable via a multiplicity of existing procedures involving the use, depending on the desired end product, of different monomeric building blocks, various chain transfer agents to achieve a target molecular weight or else monomers having reactive groups for subsequently intended after-treatments.

Industrially relevant methods of producing polyamides preferably employed according to the invention usually proceed via polycondensation in the melt. In the context of the present invention polycondensation also comprehends the hydrolytic polymerization of lactams.

Polyamides preferred in accordance with the invention are partly crystalline polyamides which can be produced from diamines and dicarboxylic acids and/or lactams having at least 5 ring members or corresponding amino acids. Contemplated reactants are preferably aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 2-methylpentane-1,5-diamine, nonane-1,9-diamine, 2,2,4- and 2,4,4-trimethylhexamethylenediamine, the isomeric diaminodicyclohexylmethanes, diaminodicyclohexylpropane, bis(aminomethyl)cyclohexane, phenylenediamine, xylylenediamine, aminocarboxylic acids, in particular aminocaproic acid, or the corresponding lactams. Copolyamides of a plurality of the monomers mentioned are included.

Polyamides particularly preferred in accordance with the invention are produced from caprolactam, very particularly preferably from t-caprolactam (in the case of PA 6) or from hexamethylenediamine (HMD) and adipic acid (in the case of PA 66).

Especial particular preference is moreover given to most compounds based on PA6, PA66 and other compounds based on aliphatic or/and aromatic polyamides/copolyamides, where there are 3 to 11 methylene groups in the polymer chain per polyamide group.

### Component B)

As component B), at least one alkali metal citrate or an iron citrate may be used. Preferred alkali metal citrates are sodium citrate or trisodium citrate [CAS No. 68-04-2] or potassium citrate [CAS No. 6100-05-6], particularly preferably trisodium citrate. In the case of sodium citrate this is preferably used in the form of monobasic sodium citrate=sodium dihydrogen citrate [CAS No. 18996-35-5] or tribasic sodium citrate dihydrate [CAS No. 6132-04-3]. In the context of this application the iron citrate used is preferably ammonium iron(III) citrate [CAS No. 1185-57-5] or iron(III) citrate [CAS No. 3522-50-7].

### Component C)

As component C), dipentaerythritol [CAS Nr. 126-58-9] is used, dipentaerythritol is available from Perstorp for example (Dipenta 93).

### Component D)

As component D), fibrous, acicular or particulate fillers and reinforcers may be used. Preference is given to carbon fibres, glass beads, ground glass, amorphous silica, calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8] or glass fibres [(CAS No. 65997-17-3]. Particular preference is given to using glass fibres, especially preferably glass fibres of E-glass. In a preferred embodiment the fibrous or particulate filers and reinforcers are provided with suitable surface modifications, especially surface modifications comprising silane chemistries, for better compatibility with the component A). Especially preferably used as component D) are glass fibres having a circular cross section and a filament diameter of about 6 to about 11 μm or flat glass fibres of noncircular cross section whose principle cross-sectional axis has a width of about 6 to about 40 μm and whose secondary cross-sectional axis has a width of about 3 to about 20 μm, where data reported in the glass fibre manufacturer technical datasheets are to be used to determine whether a glass fibre product belongs to this dimension range. For example, glass fibre CS7928 from Lanxess Deutschland GmbH (circular cross section, average diameter about 11 μm) may be used with especial preference. In the context of the present invention cross-sectional area/filament diameter are determined by means of at least one optical method according to DIN 65571. Optical methods are a) optical microscope and ocular micrometer (distance measurement cylinder diameter), b) optical microscope and digital camera with subsequent planimetry (cross section measurement), c) laser interferometry and d) projection.

### Component E)

As component E), at least one heat stabilizer additional to component B), and selected from the group of copper halides may be used. Preferably at least one copper(i) halide is used, particularly preferably at least copper(I) iodide [CAS No. 7681-65-4].

### Component F)

As component F), at least one alkali metal halide may be used. Preferred alkali metal halides are alkali metal chlorides, alkali metal bromides or alkali metal iodides, particularly preferably alkali metal halides of the metals sodium or potassium, very particularly preferably sodium chloride, potassium bromide or potassium iodide, especially preferably potassium iodide [CAS No. 7681-11-0] or potassium bromide [CAS No. 7758-02-3], especially very particularly preferably potassium bromide.

In an embodiment, it may be preferred that at least one representative of the component E) is used together with one representative of the component F). It is preferable in accordance with the invention when copper(I) iodide is used with potassium bromide. In alternative embodiments it is preferable to use copper(I) iodide with potassium iodide.

### Component G)

As a further additive, a component G) may be included, wherein component G) may be at least one substance from the group of heat stabilizers, distinct from components B) and E), UV stabilizers, gamma ray stabilizers, hydrolysis stabilizers, antistats, emulsifiers, nucleating agents, plasticizers, processing aids, impact modifiers, lubricants, demoulding agents, dyes and pigments. These and further suitable additives may be found, by the person skilled in the art, for example, in the Plastics Additives Handbook, 5th Edition, Hanser-Verlag, Munich, 2001, pages 80-84, 546-547, 688, 872-874, 938, 966. The additives for use as component (G) may be used alone or in admixture/in the form of masterbatches.

Additional heat stabilizers for use as additives in accordance with the invention and distinct from the components B) and E) may include metal halides or alkaline earth metal halides distinct from component F), preferably calcium chloride or manganese chloride, sterically hindered phenols and/or phosphites, phosphates, preferably disodium dihydrogendiphosphate, hydroquinones, aromatic secondary amines, in particular diphenylamines, substituted resorcinols, salicylates, benzotriazoles or benzophenones, and variously substituted representatives of these groups and/or mixtures thereof.

UV-Stabilizers for use as an additive in accordance with the invention may include substituted resorcinols, salicylates, benzotriazoles or benzophenones.

The impact modifiers or elastomer modifiers for use as an additive may include copolymers preferably constructed from at least two of the following series of monomers: ethylene, propylene, butadiene, isobutene, isoprene, chloroprene, vinyl acetate, styrene, acrylonitrile and acrylic esters or methacrylic esters having 1 to 18 carbon atoms in the alcohol component. The copolymers may contain compatibilizing groups, preferably maleic anhydride or epoxide.

Dyes or pigments for use as an additive in accordance with the invention may include inorganic pigments, particularly preferably titanium dioxide, ultramarine blue, iron oxide, zinc sulfide or carbon black, and also organic pigments, particularly preferably phthalocyanines, quinacridones, perylenes, and dyes, particularly preferably nigrosine or anthraquinones as colourants and also other colourants.

Nucleating agents for use as an additive in accordance with the invention may include sodium or calcium phenylphosphinate, aluminium oxide, silicon dioxide or talc. Particular preference is given to using talc [CAS No. 14807-96-6] as a nucleating agent, in particular microcrystalline talc. Talc is a sheet silicate having the chemical composition Mg₃[Si₄O₁₀(OH)₂], which, depending on the modification, crystallizes as talc-1A in the triclinic crystal system or as talc-2M in the monoclinic crystal system (http://de.wikipedia.org/wik/Talkum). Talc for use in accordance with the invention is commercially available, for example, under the name Mistron® R10 from Imerys Talc Group, Toulouse, France (Rio Tinto Group).

Lubricating and/or demoulding agents for use as an additive in accordance with the invention may include long-chain fatty acids, in particular stearic acid, salts thereof, in particular calcium or zinc stearate, and the ester derivatives or amide derivatives thereof, in particular ethylenebisstearyamide, glyceryl tristearate, stearyl stearate, montan ester waxes, in particular esters of montan acids with ethylene glycol, and low molecular weight polyethylene/polypropylene waxes in oxidized and non-oxidized form. Lubricating and/or demoulding agents particularly preferred in accordance with the invention belong to the group of esters or amides of saturated or unsaturated aliphatic carboxylic acids having about 8 to about 40 carbon atoms with saturated aliphatic alcohols or amines having about 2 to about 40 carbon atoms. In a further preferred embodiment, the inventive compositions/moulding materials comprise mixtures of the abovementioned lubricating and/or demoulding agents. Montan ester waxes, also known as montan waxes [CAS No. 8002-53-7] for short, preferred for use as demoulding agents are mixtures of straight-chain, saturated carboxylic acids having chain lengths of 28 to 32 carbon atoms. Such montan ester waxes are commercially available from Clariant International Ltd. under the name Licowax®. Used with particular preference in accordance with the invention are Licowax® E from Clariant [product ID: 105199] or a mixture of waxes, preferably mixtures of ester waxes, amide waxes and/or saponified waxes according to EP 2607419 A1, the content of which is hereby fully incorporated by reference into the present invention.

In an embodiment, the composition of the present invention may include A) PA 66, B) iron(III) citrate, C) dipentaerythritol, and D) glass fibres, and also relates to moulding materials and articles of manufacture produced therefrom.

Alternatively, in a further embodiment, the composition of the present invention may include A) PA 66, B) sodium citrate, C) dipentaerythritol, D) glass fibres, and also relates to moulding materials and articles of manufacture produced therefrom.

Alternatively, in a further embodiment, the composition of the present invention may include A) PA 66, B) iron(III) citrate, C) dipentaerythritol, D) glass fibres, and E) copper(I) iodide, and also relates to moulding materials and articles of manufacture produced therefrom.

Alternatively, in a further embodiment, the composition of the present invention may include A) PA 66, B) sodium citrate, C) dipentaerythritol, D) glass fibres, E) copper(I) iodide, and also relates to moulding materials and articles of manufacture produced therefrom.

Alternatively, in a further embodiment, the composition of the present invention may include A) PA 66, B) iron(III) citrate, C) dipentaerythritol, D) glass fibres, E) copper(I) iodide, and F) potassium bromide, and also relates to moulding materials and articles of manufacture produced therefrom.

Alternatively, in a further embodiment, the composition of the present invention may include A) PA 66, B) sodium citrate, C) dipentaerythritol, D) glass fibres, E) copper(I) iodide, and F) potassium bromide, and also relates to moulding materials and articles of manufacture produced therefrom.

Alternatively, in a further embodiment, the composition of the present invention may include A) PA 66, B) iron(III) citrate, C) dipentaerythritol, D) glass fibres, E) copper(I) Iodide, F) potassium bromide, and G) montan ester wax, preferably Licowax E, and also relates to moulding materials and articles of manufacture produced therefrom.

Alternatively, in a further embodiment, the composition of the present invention may include A) PA 66, B) sodium citrate, C) dipentaerythritol, D) glass fibres, E) copper(I) iodide, F) potassium bromide, and G) montan ester wax, preferably Licowax E, and also relates to moulding materials and articles of manufacture produced therefrom.

Alternatively, in a further embodiment, the composition of the present invention may include A) PA 6, B) iron(III) citrate, C) dipentaerythritol, and D) glass fibres, and also relates to moulding materials and articles of manufacture produced therefrom.

Alternatively, in a further embodiment, the composition of the present invention may include A) PA 6, B) sodium citrate, C) dipentaerythritol, and D) glass fibres, and also relates to moulding materials and articles of manufacture produced therefrom.

Alternatively, in a further embodiment, the composition of the present invention may include A) PA 6, B) iron(III) citrate, C) dipentaerythritol, D) glass fibres, and E) copper(I) iodide, and also relates to moulding materials and articles of manufacture produced therefrom.

Alternatively, in a further embodiment, the composition of the present invention may include A) PA 6, B) sodium citrate, C) dipentaerythritol, D) glass fibres, and E) copper(I) iodide, and also relates to moulding materials and articles of manufacture produced therefrom.

Alternatively, in a further embodiment, the composition of the present invention may include A) PA 6, B) iron(III) citrate, C) dipentaerythritol, D) glass fibres, E) copper(I) iodide, and F) potassium bromide, and also relates to moulding materials and articles of manufacture produced therefrom.

Alternatively, in a further embodiment, the composition of the present invention may include A) PA 6, B) sodium citrate, C) dipentaerythritol, D) glass fibres, E) copper(I) iodide, and F) potassium bromide, and also relates to moulding materials and articles of manufacture produced therefrom.

Alternatively, in a further embodiment, the composition of the present invention may include A) PA 6, B) iron(III) citrate, C) dipentaerythritol, D) glass fibres, E) copper(I) iodide, F) potassium bromide, and G) montan ester wax, preferably Licowax E, and also relates to moulding materials and articles of manufacture produced therefrom.

Alternatively, in a further embodiment, the composition of the present invention may include A) PA 6, B) sodium citrate, C) dipentaerythritol, D) glass fibres, E) copper(I) iodide, F) potassium bromide, and G) montan ester wax, preferably Licowax E, and also relates to moulding materials and articles of manufacture produced therefrom.

### Method

The present invention also provides a method of producing inventive compositions in the form of moulding materials, and articles of manufacture produced therefrom. The method includes mixing the components A) to D) and optionally at least one representative of the components E), F) and G) in appropriate weight fractions in at least one mixing assembly. The mixing of the components may be done at temperatures of about 220° C. to about 400° C. by conjoint mingling, blending, kneading, extruding or rolling. Preferred mixing assemblies are selected from compounders, co-rotating twin-screw extruders and Buss kneaders. It may be advantageous to premix individual components. The term ‘compound’ refers to mixtures of raw materials which have had additional fillers, reinforcers or other additives admixed with them. This does not result in dissolution of the individual raw materials in one another. Thus compounding combines at least two substances with one another to afford a homogeneous mixture. Compounding is intended to modify the properties of the raw materials to suit an application. A particular challenge is to avoid possible de-mixing of the compound over time. The procedure for producing a compound is referred to as compounding.

In a preferred embodiment the moulding materials according to the invention are produced in a two-stage process. In the first step the component B) may be blended with component A) to produce a premixture. Other components may also be blended with the component B) and the component A) in this first step. This first step may be carried out in a co-rotating twin-screw extruder, Buss kneader or planetary-gear extruder. These mixers may have a degassing function to discharge the gaseous components formed during reaction of the component B).

In a preferred embodiment the premixture in the first step additionally comprises at least one processing stabilizer as well as the two components A) and B). Preferably employed processing stabilizers are sterically hindered phenols and/or phosphites, phosphates, hydroquinones, aromatic secondary amines, in particular diphenylamines, substituted resorcinols, salicylates, benzotriazoles or benzophenones, and also variously substituted representatives of these groups and/or mixtures thereof.

The proportion of component B) in the premixture obtained from the first step may be about 1 to about 60 wt %, particularly preferably about 1 to about 30 wt %, very particularly preferably about 2 to about 20 wt %.

The component B) may alternatively be reacted in a suitable substance of component G) in a twin-screw extruder, Buss kneader or another mixing assembly suitable for heating the mixture to temperatures above the reaction temperature of the component B). It is also possible to employ a batchwise method, preferably in a stirred autoclave, in the first step.

In an alternative preferred embodiment the component B) may be used in combination with one or more chemistries which increase the reaction rate of the component B). This makes reaction of component B) at lower temperatures possible. Such chemistries, also known as activators, are described, for example, in U.S. Pat. No. 4,438,223, the content of which is hereby fully incorporated by reference. In this case, it may be preferable to employ as an activator at least one chemistry from the series of sodium or potassium hydrogencarbonate, sodium or potassium acetate, sodium or potassium carbonate, sodium or potassium chloride, sodium or potassium bromide, sodium or potassium iodide, sodium or potassium rhodanide or sodium or potassium benzoate.

In the second step the premixture from the first step may be blended with the remaining components according to the above-described methods.

After mixing, compositions in the form of moulding materials may be extruded, cooled until pelletizable, and pelletized. In one embodiment, the pelletized material comprising the inventive composition may be dried, preferably at temperatures of about 110° C. to about 130° C., particularly preferably around 120° C., in a vacuum drying cabinet or in a dry air drier, preferably for a duration of up to about 2 h, before being subjected as matrix material to an injection moulding operation, a blow moulding operation, or an extrusion process to produce inventive articles of manufacture.

The present invention thus also relates to a method of producing articles of manufacture wherein inventive compositions are blended, extruded to form a moulding material, cooled until pelletizable, pelletized, and subjected as matrix material to an injection moulding, blow moulding or extrusion operation, preferably an injection moulding operation.

It may be advantageous to directly produce so-called semi-finished products from a physical mixture produced at room temperature, preferably at a temperature of about 0° C. to about 40° C., a so-called dry-blend, of premixed components and/or individual components. In the context of the present invention, semi-finished products are prefabricated items and are formed in a first step in the production process of an article of manufacture. In the context of the present invention, ‘semi-finished products’ does not comprehend bulk goods, pelletized materials or powders because, unlike semi-finished products, these are not geometrically defined solid objects, and, as such, no “semi-finishing” of the final article of manufacture may have yet been effected. See: http://de.wikipedia.org/wiki/Halbzeug.

The processes of injection moulding, of blow moulding and of extrusion of thermoplastic moulding materials are generally known to those skilled in the art.

Methods according to the invention for producing polyamide-based articles of manufacture by extrusion or injection moulding may be carried out at melt temperatures of about 240° C. to about 330° C., preferably about 260° C. to about 310° C., particularly preferably about 270° C. to about 300° C., and optionally also at pressures of not more than about 2500 bar, preferably at pressures of not more than about 2000 bar, particularly preferably at pressures of not more than about 1500 bar and very particularly preferably at pressures of not more than about 750 bar.

Sequential co-extrusion involves expelling two different materials successively in alternating sequence. In this way, a preform having a different material composition section by section in the extrusion direction may be formed. Particular article sections may be endowed with specifically required properties by appropriate material selection, for example for articles having soft ends and a hard middle part or integrated soft gaiter regions (Thielen, Hartwig, Gust, “Blasformen von Kunststoffhohlkörpem”, Carl Hanser Verlag, Munich 2006, pages 127-129).

In the process of injection moulding a moulding material comprising the inventive compositions, preferably in pellet form, may be melted in a heated cylindrical cavity (i.e. plasticated) and injected under pressure into a heated cavity as an injection moulding material. After cooling (solidification) of the material, the injection moulding may be demoulded.

The following operations may be distinguished:
1. plastication/melting
2. injection phase (filing operation)
3. hold pressure phase (because of thermal contraction during crystallization)
4. demoulding.

In this regard, see http://de.wikipedia.org/wiki/Spritzgie%C3%9Fen. An injection moulding machine comprises a closure unit, the injection unit, the drive and the control system. The closure unit includes fixed and movable platens for the mould, an end platen, and tie bars and the drive for the movable mould platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pelletized material. The problem of melt backflow inside the screw (leakage flow) may be solved by non-return (one-way) valves.

In the injection mould, the incoming melt may be separated and cooled, and the article of manufacture to be fabricated is thus fabricated. Two halves of the mould may be required therefor. In injection moulding, the following functional systems may be distinguished:
runner system
shaping inserts
venting
machine mounting and force absorption
demoulding system and motion transmission
heating

In contrast to injection moulding, in extrusion an endless plastics extrudate of an inventive moulding material may be employed in an extruder, the extruder being a machine for producing shaped thermoplastic mouldings. Reference is made here to http://de.wikipedia.org/wiki/Extrusionsblasformen. A distinction is made between single-screw extruders and twin-screw extruders, and also between the respective subgroups of conventional single-screw extruders, conveying single-screw extruders, contra-rotating twin-screw extruders and co-rotating twin-screw extruders.

Extrusion plants may include such components as an extruder, a mould, downstream equipment, and extrusion blow moulds. Extrusion plants for producing profiles may include: extruders, profile moulds, calibrating units, cooling zones, caterpillar take-offs and roller take-offs, separating devices, and tilting chutes.

Blow moulding (see: http://de.wikipedia.org/wik/Blasformen) is a method of producing hollow articles from thermoplastics and may be counted among the special injection moulding methods. Blow moulding requires a so-called preform which is produced in an upstream operation by conventional injection moulding. The first step of the actual blow moulding process comprises heating this preform. This employs especially infrared lamps since they are not only suited for automation but also have a high output and introduce a lot of heat energy into the semi-finished product. After heating, the preform is introduced into the mould, or alternatively—depending on the machine construction—the heaters are removed from the mould. The closing of the mould results in a longitudinal stretching at the bottle neck, thereby holding the preform axially and also securing it in media-tight fashion. A gas is then introduced into the preform which expands under the applied pressure, thus reproducing the mould contours. For economic and environmental reasons the gas employed is often compressed air. After inflation, the hollow article produced cools down in the mould until it has sufficient rigidity to be ejected.

The articles of manufacture produced in accordance with the invention from the moulding materials may preferably be employed for applications where a high stability toward heat ageing is necessary, preferably in the motor vehicle, electrical, electronic, telecommunications, solar, information technology and computer industries, in the household, in sport, in medicine or in the leisure industry. Preference for such applications is given to the use of articles of manufacture in vehicles, particularly preferably motor vehicles, in particular in motor vehicle engine bays. The present invention therefore also relates to the use of thermoplastic moulding materials comprising the abovementioned compositions for the production of articles of manufacture having enhanced stability toward thermos-oxidative damage and/or photo-oxidative damage, preferably of articles of manufacture for motor vehicles, especially preferably of articles of manufacture for motor vehicle engine bays. The moulding materials according to the invention are also suitable for applications/mouldings or articles where, in addition to thermos-oxidative stability, stability toward photo-oxidative damage is also necessary, preferably solar installations.

In an embodiment, the articles of manufacture produced in accordance with the invention are semi-finished products in the form of heat-stabilized composites based on endless fibres, also known as organopanels, or else encapsulated or overmoulded composite structures. The inventive compositions and/or the inventive heat stabilizer system may be used and/or may be present either in the thermoplastic matrix of the composite structure, or in the moulding material to be moulded or in both components. Heat-stabilized composites are disclosed in WO 2011/014754 A1, for example, and overmoulded composite structures are described in WO 2011/014751 A1, for example.

The invention further relates to the use of the inventive compositions for the production of inventive articles of manufacture in the form of fibres, films or mouldings, preferably composite structures and overmoulded composite structures. The articles of manufacture in the form of fibres, films, mouldings, composite structures or overmoulded composite structures in turn find application as semi-finished products in articles for the motor vehicle, electrical, electronic, telecommunications, information technology, solar and computer industries, for the household, for sport, for medical applications or for the leisure industry, particularly preferably in articles for motor vehicles, very particularly preferably in articles for motor vehicle engine bays.

The present invention further relates to the use of inventive compositions as moulding materials for producing articles of manufacture in the form of fibres, films or mouldings of any type, preferably as matrix material for producing composite structures and overmoulded composite structures.

The present invention yet further relates to a method of heat-stabilizing polyamides and articles of manufacture produced therefrom in the form of fibres, films or mouldings, preferably composite structures and overmoulded composite structures, by using a stabilizer system composed of at least one salt of citric acid and dipentaerythritol, preferably a stabilizer system composed of at least one salt of citric acid, dipentaerythritol, copper(I) iodide and potassium bromide or preferably a stabilizer system composed of at least one salt of citric acid, dipentaerythritol, copper(I) iodide and potassium bromide or potassium iodide.

The present invention yet further relates to a method of reducing photo-oxidative damage and/or thermos-oxidative damage to polyamides/articles of manufacture produced therefrom in the form of films, fibres or mouldings, preferably composite structures and overmoulded composite structures, by using as a stabilizer system at least one salt of citric acid and dipentaerythritol, preferably a stabilizer system composed of at least one salt of citric acid, dipentaerythritol, copper(I) iodide and potassium iodide or preferably a stabilizer system composed of at least one salt of citric acid, dipentaerythritol, copper(I) iodide and potassium bromide or potassium iodide.

It will be understood that the specification and examples are illustrative but not limitative of the invention and that other embodiments within the spirit and scope of the invention will suggest themselves to those skilled in the art.

### Examples

The advantages of inventive compositions and moulding materials produced therefrom were demonstrated by initially producing a premixture of 10% iron(III) citrate and subsequently producing the polyamide moulding materials. All data reported in [%] are weight percentages.

### Production of the Polyamide Moulding Materials

The individual components listed in table 1 were mixed in a ZSK 26 Compounder twin-screw extruder from Coperion Werner & Pfleiderer (Stuttgart, Germany) at a temperature of about 290° C., extruded into a water bath, cooled until pelletizable and pelletized. The pelletized material was dried for two days at 70° C. in a vacuum drying cabinet.

The procedure for example 7 comprised initially producing a premixture of PA 66 with iron(III) citrate and subsequently producing the moulding material.

### Production of a Premixture Comprising 10% Iron(III) Citrate

10 wt % of iron (III) citrate are mixed with 90 wt % of a polyamide PA 66 in a ZSK 26 Compounder twin-screw extruder from Coperion Werner & Pfleiderer (Stuttgart, Germany) at a temperature of about 290° C., extruded into a water bath, cooled until pelletizable and pelletized. The pelletized material was dried for two days at 80° C. in a vacuum drying cabinet.

### Injection Moulding:

The obtained pelletized materials were subsequently moulded into test specimens (180 mm×10 mm×4 mm dumbbell specimens according to ISO 528 and 80 mm×10 mm×4 mm flat specimens) on an Arburg 520 C 2000-350 injection moulding machine at a material temperature of 290° C. and a mould temperature of 80° C.

### Ageing and Testing:

A portion of the test specimens obtained were subjected to tensile tests to ISO 527 and impact tests to ISO 180-1U at 23° C. Respective further portions of the test specimens were stored in a circulating air drying cabinet at 210° C. and at 220° C. for both 504 hours and 1008 hours in each case. The test specimens aged in this way were subsequently cooled to 23° C. again and likewise tested to the abovementioned standards.

TABLE 1
Compositions of the moulding materials (all data in wt %).

| | comp. | comp. | comp. | comp. | | | | | | | |
|---|---|---|---|---|---|---|---|---|---|---|---|
| ingredient | ex. 1 | ex. 2 | ex. 3 | ex. 4 | ex. 1 | ex. 2 | ex. 3 | ex. 4 | ex. 5 | ex. 6 | ex. 7 |
| glass fibres | 35.00 | 35.00 | 35.00 | 3.5 | 35.00 | 35.00 | 35.00 | 35.00 | 30.00 | 30.00 | 30.00 |
| PA66 | 61.70 | 59.70 | 61.86 | 59.86 | 59.86 | 59.86 | 59.72 | 59.72 | 64.72 | 64.72 | 37.72 |
| montan ester | 0.30 | 0.30 | 0.14 | 0.14 | 0.14 | 0.14 | 0.14 | 0.14 | 0.14 | 0.14 | 0.14 |
| wax | | | | | | | | | | | |
| potassium | | | | | | | 0.10 | 0.10 | 0.10 | 0.10 | 0.10 |
| bromide | | | | | | | | | | | |
| copper(I) iodide | | | | | | | 0.04 | 0.04 | 0.04 | 0.04 | 0.04 |
| dipentaerythritol | | | | | 2.00 | 2.00 | 2.00 | 2.00 | 2.00 | 2.00 | 2.00 |
| sodium citrate | 3.00 | 5.00 | 3.00 | 5.00 | 3.00 | | 3.00 | | 3.00 | | |
| iron(III) citrate | | | | | | 3.00 | | 3.00 | | 3.00 | |
| Premixture of | | | | | | | | | | | 30.00 |
| 10% iron citrate | | | | | | | | | | | |
| in PA 66 | | | | | | | | | | | |

TABLE 2
Compositions of the moulding materials
(all data in wt %) and ageing data.

| | cf. ex. 5 | ex. 8 | ex. 9 |
|---|---|---|---|
| ingredient | | | |
| PA66 | 63.700 | 61.700 | 61.567 |
| glass fibres | 35.000 | 35.000 | 35.000 |
| montan ester wax | 0.300 | 0.300 | 0.300 |
| potassium bromide | | | 0.098 |
| copper(I) iodide | | | 0.035 |
| dipentaerythritol | | 2.000 | 2.000 |
| iron(III) citrate | 1.000 | 1.000 | 1.000 |
| unaged properties | | | |
| breaking stress [MPa] | 202 | 191 | 197 |
| elastic modulus [MPa] | 11363 | 11406 | 11131 |
| breaking elongation [%] | 3.2 | 3.1 | 3.0 |
| Izod impact strength [kJ/m²] | 74 | 70 | 73 |
| properties after 504 h at 210° C. | | | |
| breaking stress [MPa] | 170 | 215 | 213 |
| relative preservation of breaking | 84% | 113% | 108% |
| stress | | | |
| elastic modulus [MPa] | 11791 | 12078 | 12225 |
| breaking elongation [%] | 2.0 | 3.2 | 2.9 |
| Izod impact strength [kJ/m²] | 21 | 48 | 55 |
| properties after 1008 h at 210° C. | | | |
| breaking stress [MPa] | 80 | 105 | 146 |
| relative preservation of breaking | 40% | 55% | 74% |
| stress | | | |
| elastic modulus [MPa] | 8145 | 9425 | 11127 |
| breaking elongation [%] | 1.5 | 1.6 | 1.7 |
| Izod impact strength [kJ/m²] | 14 | 27 | 30 |
| properties after 504 h at 220° C. | | | |
| breaking stress [MPa] | 169 | 186 | 199 |
| relative preservation of breaking | 84% | 97% | 101% |
| stress | | | |
| elastic modulus [MPa] | 11573 | 12055 | 12221 |
| breaking elongation [%] | 2.1 | 2.2 | 2.5 |
| Izod impact strength [kJ/m²] | 14 | 24 | 28 |
| properties after 1008 h at 220° C. | | | |
| breaking stress [MPa] | 97 | 114 | 141 |
| relative preservation of breaking | 48% | 60% | 72% |
| stress | | | |
| Modulus of elasticity [MPa] | 10924 | 11090 | 11644 |
| Elongation at break [%] | 1.2 | 1.3 | 1.5 |
| Izod impact strength [kJ/m²] | 14 | 24 | 28 |

### Materials Used:

PA66: Polyamide 66, for example Vydyne® 50 BWFS from Ascend Performance Materials LLC

Montan ester wax, for example Licowax® E from Clariant GmbH

Glass fibres, for example CS7928 from Lanxess Deutschland GmbH

Potassium bromide, d₉₉<70 μm

Copper(I) iodide, d₉₉<70 μm

Iron(III) citrate [CAS No. 3522-50-7] for example from Sigma-Aldrich

Monosodium citrate [CAS No. 18996-35-5] for example from Sigma-Aldrich

Dipentaerythritol [CAS No. 126-58-9] DiPenta93 from Perstorp Service GmbH

What is claimed is:

1. A composition comprising:
A) at least one polyamide or copolyamide;
B) at least one salt of citric acid;
C) dipentaerythritol; and
D) at least one filler or reinforcer.

2. The composition according to claim 1, further comprising at least one further heat stabilizer E).

3. The composition according to claim 2, further comprising at least one alkali metal halide F).

4. The composition according to claim 3, further comprising at least one further additive G).

5. The composition according to claim 2, wherein the heat stabilizer E) comprises at least one copper(I) halide.

6. The composition according to claim 3, wherein the alkali metal halide F) comprises at least one of: an alkali metal chloride, an alkali metal bromide, and an alkali metal iodide.

7. The composition according to claim 3, wherein the alkali metal halide F) comprises at least one of: sodium halide and potassium halide.

8. The composition according to claim 3, wherein the alkali metal halides F) comprises at least one of: sodium chloride, potassium bromide, and potassium iodide.

9. The composition according to claim 4, wherein the at least one further additive G) comprises at least one substance from the group of heat stabilizers distinct from components B) and E), UV stabilizers, gamma ray stabilizers, hydrolysis stabilizers, antistats, emulsifiers, nucleating agents, plasticizers, processing aids, impact modifiers, lubricants, demoulding agents, dyes, and pigments.

10. The composition according to claim 1, wherein the at least one filler or reinforce D) comprises at least one of fibrous fillers, acicular fillers, particulate fillers, fibrous reinforcers, acicular reinforcers, and particulate reinforcers.

11. The composition according to claim 1, wherein the at least one filler or reinforce D) is selected from a group that includes carbon fibres, glass beads, ground glass, amorphous silica, calcium silicate, calcium metasilicate, magnesium carbonate, kaolin, calcined kaolin, chalk, powdered or ground quartz, mica, phlogopite, barium sulfate, feldspar, wollastonite, montmorillonite, and glass fibres.

12. The composition according to claim 1, wherein the at least one filler or reinforce D) comprises at least one of:
glass fibres having a circular cross section and a filament diameter of about 6 to about 11 μm, or
flat glass fibres of noncircular cross section whose principle cross-sectional axis has a width of about 6 to about 40 μm and whose secondary cross-sectional axis has a width of about 3 to about 20 μm.

13. The composition according to claim 1, further comprising at least one of:
at least one further heat stabilizer E);
at least one alkali metal halide F); and
at least one further additive G).

14. The composition according to claim 13, wherein:
the composition comprises each of components A), B), C), D), E), F) and G);
the salt of citric acid B) comprises at least one of: an alkali metal citrate and an iron citrate;
the filler or reinforce D) comprises at least one of: carbon fibres, glass beads, ground glass, amorphous silica, calcium silicate, calcium metasilicate, magnesium carbonate, kaolin, calcined kaolin, chalk, powdered or ground quartz, mica, phlogopite, barium sulfate, feldspar, wollastonite, montmorillonite, and glass fibres;
the heat stabilizer E) comprises at least one copper(I) halide;
the alkali metal halide F) comprises at least one of: an alkali metal chloride, an alkali metal bromide, and an alkali metal iodide; and
the further additive G) comprises at least one substance from the group of heat stabilizers distinct from components B) and E), UV stabilizers, gamma ray stabilizers, hydrolysis stabilizers, antistats, emulsifiers, nucleating agents, plasticizers, processing aids, impact modifiers, lubricants, demoulding agents, dyes, and pigments.

15. The composition according to claim 14, comprising:
15 to 94.85 wt % component A),
0.05 to 10 wt % component B),
0.1 to 5 wt % component C),
5 to 70 wt % component D),
0.03 to 0.5 wt % component E),
0.01 to 0.5 wt % component F), and
0.05 to 5 wt % component G),
wherein the sum of all weight percentages is always 100 wt %.

16. The composition according to claim 15, wherein:
the at least one polyamide or copolyamide A) is polyamide 6 or polyamide 66;
the at least one salt of citric acid B) is at least one of sodium citrate, trisodium citrate, ammonium iron(III) citrate, and iron(III) citrate;
the at least one filler or reinforce D) comprises at least one of:
glass fibres having a circular cross section and a filament diameter of about 6 to about 11 μm, and
flat glass fibres of noncircular cross section whose principle cross-sectional axis has a width of about 6 to about 40 μm and whose secondary cross-sectional axis has a width of about 3 to about 20 μm,
the heat stabilizer E) comprises is copper(I)iodide;
the alkali metal halide F) comprises potassium bromide; and
the at least one further additive G) comprises at least one substance from the group of heat stabilizers distinct from components B) and E), UV stabilizers, gamma ray stabilizers, hydrolysis stabilizers, antistats, emulsifiers, nucleating agents, plasticizers, processing aids, impact modifiers, lubricants, demoulding agents, dyes, and pigments.

17. The composition according to claim 1, comprising:
15 to 94.85 wt % component A),
0.05 to 10 wt % component B),
0.1 to 5 wt % component C), and
5 to 70 wt % component D),
wherein the sum of all weight percentages is always 100.

18. A stabilizing system for the heat-stabilizing of polyamides and articles made therefrom, the stabilizing system comprising:
at least one salt of citric acid, and
dipentaerythritol.

19. The stabilizing system according to claim 18, further comprising copper(I) iodide.

20. The stabilizing system according to claim 19, wherein the salt of citric acid is at least one of sodium citrate, trisodium citrate, ammonium iron(III) citrate, and iron(III) citrate.
